(19) United States
(12) Patent Application Publication
(10) Pub. No.: US 2004/0233843 A1
(43) Pub. Date: Nov. 25, 2004

(54) Method and system for path protection in a communications network

(76) Inventor: Andrew James Barker, Nottingham (GB)

Correspondence Address: KIRSCHSTEIN, OTTINGER, ISRAEL, & SCHIFFMILLER, P.C., 489 FIFTH AVENUE, NEW YORK, NY, 10017

(21) Appl. No.: 10/477,668

(22) PCT Filed: May 15, 2002
(86) PCT No.: PCT/GB02/02270

(30) Foreign Application Priority Data
May 15, 2001 (GB) 0111869.4

(51) Int. Cl. H04L 12/26

(52) U.S. Cl. 370/225; 370/237; 709/239

(57) ABSTRACT

Restoration of a failed link on a network is achieved by reserving a portion of the transmission bandwidth for at least some of the links connecting nodes of the network. The reserved portion of the transmission bandwidth is used for the transmission of traffic diverted from a failed link to provide a restoration path for that diverted traffic thereby enabling a protection path to be determined dynamically. The reserved portion is preferably configured in a block so that contiguous concatenated payloads can be transmitted across the protection bandwidth.

This invention relates to restoration protection in communication networks. More particularly it concerns restoration protection in connection orientated communications networks such as optical communication networks.

Communication networks can be classified as those which are connection orientated in which traffic is routed across the network over a circuit (path) and connectionless networks in which traffic is independently routed across the network.

Communication networks frequently use restoration to protect the network during failures on the network. Such networks include Internet protocol (IP) and asynchronous transfer mode (ATM) networks. IP and ATM networks are example of connectionless networks and consequently do not have permanent protection paths reserved for any given path. Protection is achieved by determining a new route (re-routeing) for traffic after a failure has been detected. The network must have a level of capacity, or spare bandwidth, to ensure an alternate route is available. This can be 20% or so of the total bandwidth. In contrast a 1+1 allocation requires 100% over provision of bandwidth. Since the location of a failure is unknown prior to that failure, spare bandwidth must be evenly distributed across the network to cater for any possible failures.

For IP/ATM networks, the provision of a protection path in the network is straightforward. The links connecting equipment have large capacity relative to the small packets, or cells, carried over the links. The granularity is small and providing spare bandwidth is therefore not a problem.

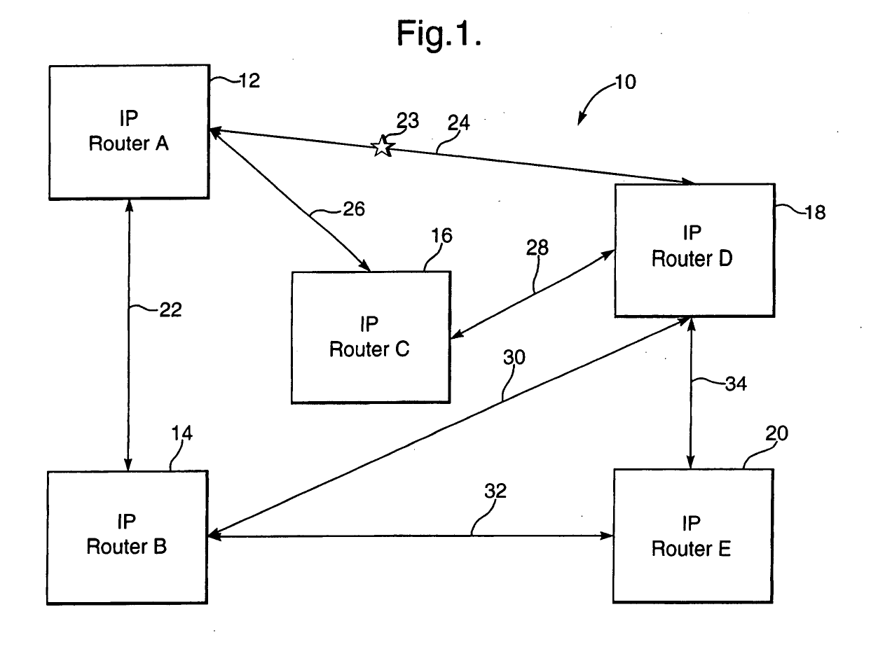

FIG. 1 shows an IP mesh network 10 of IP routers; the IP routes, or nodes, 12 to 20 are configured in a mesh. Each link 22 to 34 has, for example, a nominal spare capacity of 20%. If a fault 23 occurs on link 24 between nodes 12 (IP Router A) and 14 (IP Router D), the resulting loss of path disrupts the transmission of packets from nodes A to D and from A to E via D. Once the fault has been detected by the routers an alternative route can be established. For example, packets destined for D from A can be re-routed by one of three paths: A-B-E-D, A-B-D or A-C-D. Packets destined for E from A could also be disrupted by the fault 23. Alternative routes avoiding the faulty link 24 are A-C-D-E, A-B-E and A-B-D-E.

A major factor that allows this type of re-routeing protection is the low granularity of the packets relative to the link bandwidth. This enables spare bandwidth in the alternative routes to be found easily. Furthermore, the ability to transport packets over links with different bit rates makes finding an alternate link more simple. For example, the link 24 between A-D could be 622 Mbps, A-C could be 10 Gbps, and so on. The nature of the data packets allows them to be sent along any link irrespective of that link's bit rate. There may, however, be a slight change in the delay time taken for the packet to traverse the network.

Optical networks presently have highly resilient protection based on a 1+1 provisioning. Once a path (working link) is set up, a separate path is established as a protection link. This protection link is dedicated to the working link.

The 1+1 system is robust but requires an over provision of bandwidth by 100% resulting in high expenditure to protect a network; double the amount of optical fibres and equipment is required if a link is to be protected. Furthermore, the protection path must be separate from the working path for both the equipment and the fibres.

Generalised multi protocol label switching (GMPLS) has been proposed for controlling optical networks. GMPLS allows for the centralised management of optical networks to develop into networks where connections are set up on request from client equipment. The traditional 1+1 protection system will most likely be replaced by a type of protection comprising restoration methods, as used in data networks. The potential advantages of this are the reduction in equipment costs and separacy tests since protection paths are set up dynamically taking account of failures.

However, this type of restoration has problems in optical networks. These problems are caused by the much larger granularity of the data packets when compared to present IP/ATM data networks. For example, in synchronised digital hierarchy (SDH), the basic unit is typically 155 Mbps for synchronous transport module 1 (STM-1). STM-16 has a 2.5 Gbps and STM-64 a 10 Gbps size. This can be broken down into 16 or 64 STM-1 basic units respectively but this STM-1 basic unit must be transported whole. Unlike packets, it is not possible to fragment the constituent packet over a number of paths. In contrast, for example, a 10 G IP data stream has thousands of packets that can be separately routed, over any available bit rate.

When a failure occurs in an optical network, the optical network has insufficient capacity available to spread the signal across the network diversely. It is not possible to successfully re-route all the affected traffic due to the relatively large granularity of the packets compared to the link bandwidth.

Moreover, some traffic connections use contiguously concatenated interfaces. Such interfaces are typically used by routers, or switchers, for large bandwidth connections. Here, a number of basic units are added together (concatenated) to form a contiguous payload. For example, four 155 Mbps (STM-1) packets can be concatenated to form a 622 Mbps payload (STM-4c).

There are strict rules determining how concatenated payloads can be transmitted. For example, the payloads must be transmitted together in consecutive positions in a frame, and they must occupy specific positions within the frame structure. Thus, unlike the example above, concatenated STM-16c and STM-64c traffic cannot be broken down into STM-1 units.

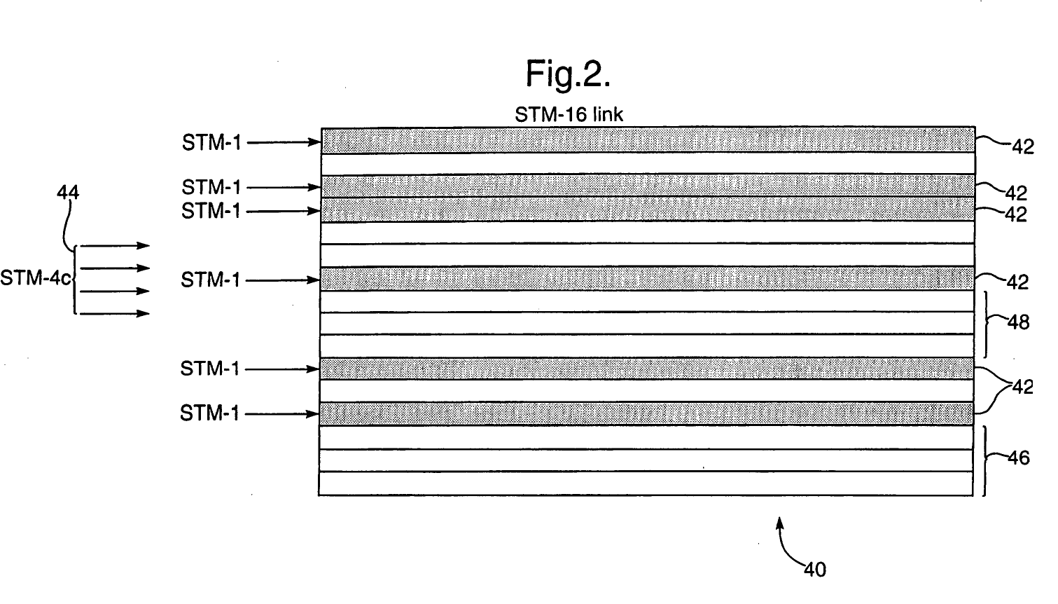

Network bandwidth fragmentation occurs as connections are set up and taken down. It is likely that sufficient bandwidth is available on a link for a concatenated payload, but the bandwidth can be in the wrong position to allow concatenated payloads to be transmitted. FIG. 2 shows an example of such an occurrence. Referring to FIG. 2, a STM-16 link 40 with a 2.5 Gbps capacity transmits ten STM-1 payloads 42, each of 155 Mbps. There is sufficient bandwidth to transmit a concatenated STM-4c payload 44 of 622 Mbps. However, fragmentation of the STM-1 payloads 42 has resulted in there being no way of transmitting the STM-4c payload since there is not a block of four by STM-1 bandwidth available. Two blocks of three by STM-1 bandwidth 46 and 48 are available, but these have insufficient bandwidth to transmit the payload 44. The signal can thus not be carried on this link.

Such fragmentations cause problems when restoration protection is implemented in an optical network. Restoration protection limits the bandwidth available across the network. Therefore the likelihood of finding spare bandwidth to restore a concatenated payload is small, making known restoration protection techniques inappropriate for contiguously concatenated interfaces.

The present invention aims to ameliorate the problems associated with implementing restoration protection in optical networks. Broadly, this is achieved by providing sufficient reserved bandwidth on the network's links which provides a restoration path to restore a failed link in the network.

More specifically, there is provided a communications network, comprising a plurality of nodes connected by a plurality of links, each link having a transmission bandwidth, characterised in that a portion of the transmission bandwidth of at least some of the links is reserved for transmission of traffic diverted from a failed link to provide a restoration path for that diverted traffic.

The invention also provides a link in an optical communication network for transmitting data between two nodes on the network, the link having a transmission bandwidth characterised in that a portion of the transmission bandwidth is reserved for transmission of traffic diverted from a failed link to provide a restoration path for that diverted traffic.

The invention also provides a method for restoring a failed link between two nodes on a communications network, wherein the network comprises a plurality of nodes connected by a plurality of links, the links having a transmission bandwidth for transmitting traffic over the network; the method characterised by reserving a portion the transmission bandwidth of at least some of the link's for transmission of diverted traffic from the failed link, thereby providing a restoration path between the two nodes for the diverted traffic.

Embodiments of the invention have the advantage that restoration paths can be implemented for connection orientated network, such as optical networks, by reserving a portion of a link's bandwidth for restoration. Traffic is diverted onto the restoration bandwidth if the preferred path is damaged or becomes inoperable. Contiguously concatenated payloads can be transmitted over the restoration path by reserving a block of bandwidth for restoration.

Furthermore, a reverter provides means for reverting diverted traffic back on to a failed link when the failed link becomes operable, thus providing the advantage of maintaining an even spread of restoration paths across the network.

Also, contiguously concatenated payloads can be converted to virtually concatenated payloads when a payload enters the optical network. This has the advantage that the virtually concatenated payloads can be transmitted over different links across the network. The virtually concatenated payloads are recombined at the exit of the network to a contiguously concatenated payload, thus providing a transparent transmission of the payload.

Embodiments of the present invention will now be described, by way of example only, and with reference to the drawings, in which:

FIG. 1, referred to above, is a schematic representation of a communication network in a mesh configuration;

FIG. 2, referred to above, is a schematic representation of an STM-16 link;

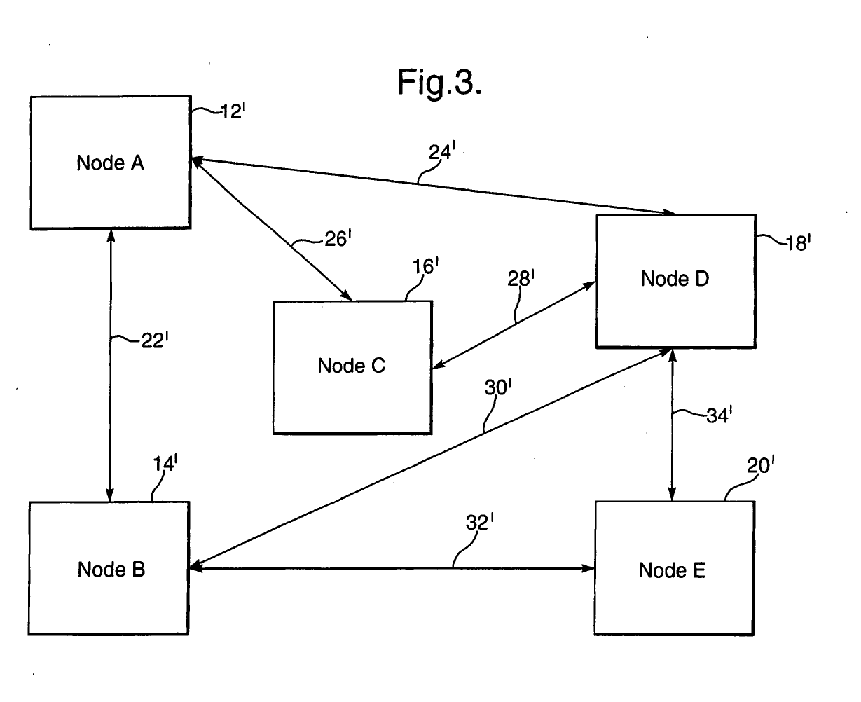

FIG. 3 is a schematic representation of a network embodying the present invention; and

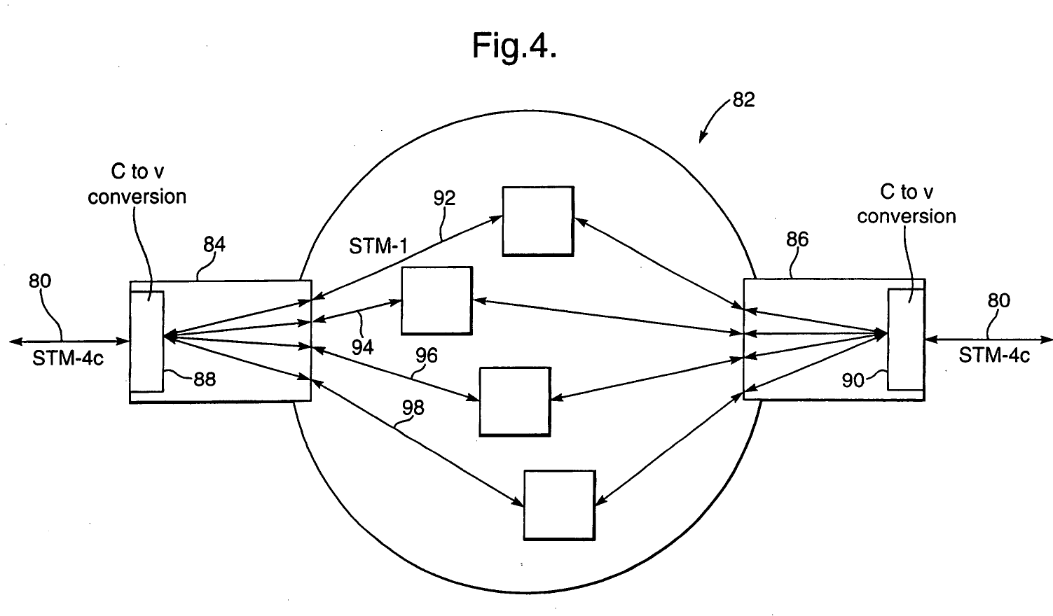

FIG. 4 is a schematic representation of a conversion of a contiguous to virtually concatenated payload embodying the present invention.

Embodiment of the present invention to be described provide specifically allocated bandwidth in a network for restoration. This restoration bandwidth, or protection bandwidth, is not allocated to any specific path since it is not possible to determine where the restoration bandwidth is required until a failure occurs. It is, however, reserved for restoration. It is preferable to allocate the restoration bandwidth evenly throughout the network to ensure that every link has spare capacity allocated, dedicated for restoration.

Systems where bandwidth is shared for protection are known, for example, a 1:N multiplexed section protection system. However, such systems are limited in that the protection bandwidth is specified to a few designated paths, all travelling to and from the same point. Embodiments of the present invention provide restoration bandwidth spread across the network. There is no allocation to the paths that the bandwidth might be protecting should a failure occur. The protection is determined dynamically when a failure occurs.

An example of how restoration bandwidth is used to restore a link is shown in FIG. 3. Nodes 12′, 14′, 16′, 18′ and 20′ are interconnected by links 22′ to 34′. In this example each link has STM-16 capacity having STM-1 granularity. There are four connections between the nodes that uses link 24′ these being the connections: 14′ to 12′ to 18′, 12′ to 18′ and 12′ to 18′ to 20′. If link 24′ fails, all of these connections are lost. However, due to the diversely available protection bandwidth, it is possible to restore the traffic through the following routes:

four connections 14′to 12′ to 18′can be protected as four connections 14′ to 18′;

four connections 12′ to 18′ can be protected as four connections 12′ to 16′ to 18′; and

four connections 12′ to 18′ to 20′ can be protected as four connections 12′ to 14′ to 20′.

The method for determining failure is preferably derived from standard failure conditions defined in the transmission data standards. The process of finding an alternative route is determined by the use of the protocols used in the data networks for multi protocol label switching (MPLS) standard, or GMPLS standard implemented on optical networks.

The MPLS protocols of the data networks require modification to operate effectively in optical networks. Furthermore, suitable modifications to the protocols are required to recognise the existence of reserved restoration bandwidth. Such modifications ensure that the restoration bandwidth is not used for normal traffic; in this embodiment the restoration bandwidth must be used only for protecting paths lost through failure of that path. The modifications may require an additional class of set up requests and resource allocation.

The restoration bandwidth needs to be spread evenly across the network to provide protection against every possible failure. A typical failure is of a complete link. When such failures occur the preferred path for the traffic transmitted over that link is lost. As a result, these failures result in a large proportion of the protection bandwidth being utilised during the failure.

Once the failure has been repaired, the now operating link has no traffic because it's traffic has been re-routed. However, the protection bandwidth remains locked out since it continues to carry the previously damaged link's traffic. By locked out it is meant that the restoration bandwidth is still being used to provide a path for the traffic previously transmitted over the damaged link. Thus, the restoration bandwidth is no longer evenly spread across the network. If another failure occurs, it may be difficult to find sufficient restoration bandwidth to restore the subsequent failure.

In view of this, the protection bandwidth is revertive. By revertive, it is meant that the protected diverted traffic is reverted back to it's original path once the damaged link on which the diverted traffic previously travelled has been repaired. In this way the protection bandwidth is released for future use once the damaged link becomes operable.

In an alternative embodiment, it is possible to restore a failure without using the protection bandwidth should sufficient normal bandwidth be available on the network. Traffic can be re-routed on the normal bandwidth to avoid using the protection bandwidth. The routeing protocols are designed in this embodiment to re-route traffic from a damaged link using normal bandwidth, if it is available. If sufficient normal bandwidth is unavailable, the traffic is re-routed onto the protection bandwidth. In this embodiment, reversion is not essential when the protection bandwidth has not been used.

In certain circumstances when the traffic is re-routed over several links, it may be preferable to use the protection bandwidth on some links, whilst the normal bandwidth is used on other links. This will be dependent on the levels of traffic traversing each link.

In another alternative embodiment, the protection bandwidth is utilised for normal traffic on a casual basis when the protection bandwidth is not required. Preferably the casual traffic is low priority traffic and is dropped from the protection bandwidth as soon as a failure occurs on the network, and the protection bandwidth is required for re-routeing traffic.

In a further alternative embodiment, the protection bandwidth is virtual. By virtual it is meant that the protection bandwidth is not solely reserved for protection. In this further alternative embodiment, the routeing protocols are required to allocate protection bandwidth more evenly across the network to ensure a diverse availability of spare bandwidth. Suitable alarms should be raised if it becomes difficult to route a circuit without falling below a minimum threshold of spare bandwidth. Also, once a failure has been repaired, it is necessary to revert the bandwidth to ensure an even spread of spare bandwidth across the network.

Contiguously concatenated interfaces can be problematic for reversion due to the requirement for a single block of bandwidth. Finding an alternative route across the network can be difficult when restoration protection protocols are used and spare bandwidth is limited.

In a yet further alternative embodiment, contiguously concatenated payloads are converted to virtually concatenated payloads before transmission across the network to enable the network to use reversion. In this yet further alternative embodiment, the virtually concatenated payload, which comprises associated blocks, can then be transported across the network by independently routeing the blocks. As the associated blocks exit the optical network they are recombined into a contiguous block. Thus, the process is transparent to the client.

Referring to FIG. 4, a contiguously concatenated STM-4c payload 80 is traversing an optical network 82. At the ingress point 84 and egress point 86 on the optical network, the signal undergoes a contiguous to virtual conversion at the contiguous to virtual converters 88 and 90. The optical network now has four separate STM-1 payloads 92, 94, 96, 98 (or signals) to transmit, rather than a single STM-4c payload. It is, therefore, easier to route the signal across the network. It is not required to find one large allocation of bandwidth and each STM-1 payload can use different paths to cross the network. If a failure of a link does occur, alternative routes can be found more easily. The individual STM-1 payloads are easier to re-route than the larger single STM-4c payload. Furthermore, a failure is less likely to affect all of the STM-1 payloads because they can travel over different links. In which case, the restoration process has fewer signals to restore.

The four associated STM-1 payloads are suitably labelled so that each one reaches the required destination and is recombined in the required order with the other components of the original STM-4c payload. At the exit 86 from the optical network, the four STM-1 signals are combined and converted back to the single STM-4c contiguous payload 80 by the contiguous to virtual converter 90. Suitable buffering is likely to be required to cater for any time delays associated with the different time taken for each STM-1 payload to traverse the network.

It is particularly preferred to transport the payload as a virtually concatenated payload since a lot of existing transmission equipment can not handle complex contiguously concatenated payloads. Virtual concatenation thus allows contiguous signals to be transmitted on legacy equipment.

In this yet further alternative embodiment, such conversion provides a realistic way to handle contiguously concatenated payloads on a system where restoration protection is required. Contiguous concatenated interfaces are frequently encountered as many IP routers and data switches use them.

Costs of installing and maintaining a network embodying the present invention are greatly reduced since only a single infrastructure is required. It is not necessary to have double the amount of links, as a 1+1 protection system requires.

It is not necessary for all links in the network to provide restoration protection. It is important to ensure that there is enough transmission bandwidth reserved for restoration protection such that an alternative path can be found. If there are multiple links between two nodes, only a proportion need bandwidth reserved for use as a restoration path.

Other embodiments of the method and system falling within the scope of the claims will be envisaged by a skilled person. For example, the present invention is applicable to other systems, for example SONET systems using STS-1 etc, as well as photonic systems that switch wavelength. Furthermore, a restoration path might be set up as a series of links, arranged in parallel. It may be possible to use several restoration paths simultaneously to restore a single link.

The embodiments described are not limited to optical networks. For example, SDH frames can be used to transport electrical signals and for Radio links. The embodiments described are applicable to any situation in which the units being transmitted are at a fixed bit rate and fairly large in contrast to IP/ATM packets. The present invention does however finds particular application to connection orientated communication networks.

1-22. (Canceled)

23. A communications network, comprising: a plurality of nodes; and a plurality of links for connecting the nodes, each link having a transmission bandwidth, a portion of the transmission bandwidth of at least some of the links being reserved for transmission of traffic diverted from a failed link to provide a restoration path for that diverted traffic.

24. The network of claim 23, wherein the traffic comprises a contiguously concatenated payload.

25. The network of claim 23, wherein the portion reserved for restoration comprises a block of bandwidth.

26. The network of claim 23, further comprising a convertor at an entry to or exit from the network for converting between a contiguously concatenated payload and a plurality of virtually concatenated payloads for transmission of the plurality of virtually concatenated payloads over the network.

27. The nature of claim 26, wherein each of the plurality of virtually concatenated payloads is transmitted over different links.

28. The network of claim 23, further comprising means for transmission of a low priority payload over the portion of a given link if said portion is not required for transmission of traffic diverted from the failed link.

29. The network of claim 23, wherein the restoration path between any two nodes connected by a single link comprises a plurality of links.

30. The network of claim 29, wherein the restoration path extends over the plurality of links, including the portion of the transmission bandwidth for transmitting traffic of at least one of the links.

31. The network of claim 23, further comprising a reverter for reverting the diverted traffic to the failed link from the restoration path when the failed link becomes operable.

32. The network of claim 23, wherein the network carries synchronous digital hierarchy (SDH) or synchronous optical network (SONET) signals.

33. The network of claim 23, wherein the network is an optical network.

34. A link for a communications network for transmitting data between two nodes on the network, the link comprising: a transmission bandwidth having a portion reserved for transmission of traffic diverted from a failed link to provide a restoration path for that diverted traffic.

35. A method of restoring a failed link between two nodes on a communications network in which a plurality of nodes is connected by a plurality of links, the links having a transmission bandwidth for transmitting traffic over the network, the method comprising the steps of: reserving a portion of the transmission bandwidth of at least some of the links for transmission of diverted traffic from the failed link, thereby providing a restoration path between the two nodes for the diverted traffic.

36. The method according to claim 35, wherein the traffic comprises a contiguously concatenated payload.

37. The method according to claim 35, wherein the portion is a block of bandwidth.

38. The method according to claim 35, further comprising the step of converting the traffic between a contiguously concatenated payload and a plurality of virtually concatenated payloads as the traffic enters or exits the network, the plurality of virtually concatenated payloads being transmitted over the network.

39. The method according to claim 38, further comprising the step of transmitting each of the virtually concatenated payloads over a different link.

40. The method according to claim 35, further comprising the step of transmitting low priority traffic over the restoration path when the link is operative.

41. The method according to claim 36, further comprising the step of reserving the restoration path for transmission of the payload between first and second nodes.

42. The method according to claim 36, wherein the restoration path between any two nodes connected by a single node comprises a plurality of links.

43. The method according to claim 42, further comprising the step of extending the restoration path over a plurality of links, including the portion of the transmission bandwidth for transmitting the traffic of at least one of the links.

44. The method according to claim 35, further comprising the step of reverting the traffic on to the failed link from the restoration path when the failed link becomes operative.
